(19) United States
(12) Patent Application Publication
(10) Pub. No.: US 2023/0362639 A1
(43) Pub. Date: Nov. 9, 2023

(54) METHOD AND APPARATUS FOR TRANSFERRING NETWORK INFORMATION TO AI/ML APPLICATION IN WIRELESS COMMUNICATION SYSTEM

(71) Applicant: Samsung Electronics Co., Ltd., Suwon-si (KR)

(72) Inventors: Jungshin PARK, Suwon-si (KR); Hyesung KIM, Suwon-si (KR); Dongeun SUH, Suwon-si (KR)

(21) Appl. No.: 18/312,424

(22) Filed: May 4, 2023

(30) Foreign Application Priority Data
May 4, 2022 (KR) 10-2022-0055649
Mar. 9, 2023 (KR) 10-2023-0031170

(51) Int. Cl. H04W 12/06; H04W 8/20

(52) U.S. Cl. CPC H04W 12/06; H04W 8/20

(57) ABSTRACT

Disclosed is a 6G communication system for achieving a high data transmission rate and a super-low latency time after 4G and 5G communication systems. A method performed by a terminal in a wireless communication system comprises steps of transmitting, to an access and mobility management function (AMF), an identifier for an application and network state parameter list for the application, wherein the application is an artificial intelligence (AI) application or a machine learning (ML) application; receiving, from the AMF, authentication information for a network state information request or a network state analysis information request and address information on a first network entity collecting network state information; transmitting, to the first network entity based on the address information, the network state information request or the network state analysis information request based on the authentication information; receiving, from the first network entity, network state information corresponding to the network state information request or network state analysis information corresponding to the network state analysis information request; and selecting, an AI or ML model based on at least one of the network state information or the network state analysis information.

### CROSS-REFERENCE TO RELATED APPLICATIONS

This application is based on and claims priority under 35 U.S.C. 119 to Korean Patent Application Nos. 10-2022-0055649 and 10-2023-0031170, filed on May 4, 2022 and Mar. 9, 2023, in the Korean Intellectual Property Office, the disclosures of which are herein incorporated by reference in their entirety.

### BACKGROUND

### 1. Field

The present disclosure relates to a method and an apparatus for transferring network information from a wireless communication system to a machine learning application of a terminal in a wireless communication system.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G.

In the initial state of 5G mobile communication technologies, in order to support services and to satisfy performance requirements in connection with enhanced Mobile BroadBand, (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (Bandwidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there is ongoing discussion regarding improvement and performance enhancement of initial 5G mobile communication technologies in view of services to be supported by 5G mobile communication technologies, and there has been physical layer standardization regarding technologies such as V2X for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is impossible, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR, VR, and the like (XR=AR+VR+MR), 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The Internet, which is a human centered connectivity network where humans generate and consume information, is now evolving to the Internet of things (IoT) where distributed entities, such as things, exchange and process information. The Internet of everything (IoE) may be an example of a combination of the IoT technology and the big data processing technology through connection with a cloud server or like.

As technology elements, such as “sensing technology”, “wired/wireless communication and network infrastructure”, “service interface technology”, and “security technology” have been demanded for IoT implementation, a sensor network, a machine-to-machine (M2M) communication, machine type communication (MTC), and so forth have been recently researched.

Such an IoT environment may provide intelligent Internet technology (IT) services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, machine type communication (MTC), and machine-to-machine (M2M) communication may be implemented by beamforming, MIMO, and array antennas. Application of a cloud radio access network (cloud RAN) as the above-described big data processing technology may also be considered an example of convergence of the 5G technology with the IoT technology.

With the development of a mobile communication system as described above, a terminal has become capable of easily using a computing ability provided by a server of a network through the mobile communication system as necessary. Accordingly, the use of AI applications that apply, as an example, a machine learning (ML) algorithm requiring a complex operation used to be considered impossible to be performed by the terminal, is gradually being considered. These AI applications use a resource of a network server through a wireless communication system, and the performance of the applications experienced by a user is greatly affected according to a communication state of the wireless communication system. Accordingly, a technology capable of controlling an ML model or algorithm in response to a state of a wireless communication system is required.

The above information is presented as background information only to assist with an understanding of the disclosure. No determination has been made, and no assertion is made, as to whether any of the above might be applicable as prior art with regard to the disclosure.

### SUMMARY

The present disclosure provides a method and an apparatus in which a terminal requests and receives network state information or network state analysis information in a wireless communication system and determines an ML model and an algorithm to be applied to an application therefrom.

The present disclosure provides a method and an apparatus for providing network state information or analysis information requested by a terminal (UE) in a wireless communication system.

The present disclosure provides a method and an apparatus for authenticating, in a network, a terminal having requested network state information or analysis information in a wireless communication system.

The present disclosure provides a method and an apparatus for controlling a signal flow between a terminal and network function (NF) entities for transferring network state information or analysis information to the terminal.

According to an embodiment of the present disclosure, there is provided a method performed by a terminal in a wireless communication system, including transmitting, to an access and mobility management function (AMF), an identifier for an application and network state parameter list for the application, wherein the application is an artificial intelligence (AI) application or a machine learning (ML) application; receiving, from the AMF, authentication information for a network state information request or a network state analysis information request and address information on a first network entity collecting network state information; transmitting, to the first network entity based on the address information, the network state information request or the network state analysis information request based on the authentication information; receiving, from the first network entity, network state information corresponding to the network state information request or network state analysis information corresponding to the network state analysis information request; and selecting, an AI or ML model based on the at least one of the network state information or the network state analysis information.

In an embodiment, the network state information request or the network state analysis information request is transmitted to the AMF from the first network entity, and the network state information request or the network state analysis information request is authenticated by the AMF based on the authentication information.

In an embodiment, the method performed by the terminal includes receiving, from the AMF, information on whether to accept provision of the network state information, an identifier list of allowed application and a list of network state parameters allowed for the application.

In an embodiment, the information on whether to accept provision of the network state information is determined based on subscription information received from a united data management (UDM).

According to an embodiment of the present disclosure, there is provided a method performed by an access and mobility management function (AMF) in a wireless communication system, the method including receiving, from a terminal, an identifier for an application and network state parameter list for the application, wherein the application is an artificial intelligence (AI) application or a machine learning (ML) application; transmitting, to the terminal, authentication information for a network state information request or a network state analysis information request and address information on a first network entity collecting network state information; receiving, from the first network entity, the network state information request or the network state analysis information request; and performing authentication on the received network state information request or the received network state analysis information based on the authentication information.

The present disclosure enables an AI/ML application operating on a terminal in a wireless communication system to determine an appropriate AI/ML model and algorithm based on a network state.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a configuration diagram of a wireless communication network including a network data collection and analysis function (NWDAF) according to an embodiment of the present disclosure;

FIG. 2 illustrates a general structure of a wireless communication system in which an AI/ML application of a terminal receives and applies network congestion information provided by a communication service provider according to an embodiment of the present disclosure;

FIGS. 3A and 3B illustrate a signal flow diagram of an operation of receiving a request for transfer of network state information or network state analysis information from an AI/ML application of a terminal, collecting the network state information or analysis information, and transferring the information to the terminal according to an embodiment of the present disclosure;

FIG. 4 illustrates a structure of a terminal in a wireless communication system according to an embodiment of the present disclosure; and

FIG. 5 illustrates a structure of a network entity which performs a network function according to an embodiment of the present disclosure.

### DETAILED DESCRIPTION

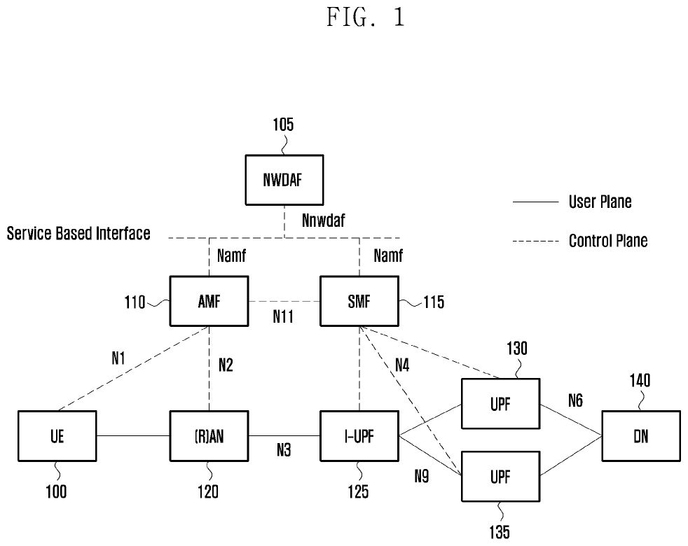

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail in conjunction with the accompanying drawings.

In describing embodiments of the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more CPUs within a device or a security multimedia card. Further, the “unit” in the embodiments may include one or more processors.

In the following description, some of terms and names defined in the 3rd generation partnership project long term evolution (3GPP LTE)-based communication standards (e.g., standards for 5G, NR, LTE, and similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of convenience. Therefore, the disclosure is not limited by the terms as used below, and other terms referring to subjects having equivalent technical meanings may be used.

The following detailed description of embodiments of the disclosure is mainly directed to New RAN (NR) as a radio access network and Packet Core as a core network (5G system, 5G Core Network, or new generation core (NG Core)) which are specified in the 5G mobile communication standards defined by the 3rd generation partnership project long term evolution (3GPP LTE) that is a mobile communication standardization group, but based on determinations by those skilled in the art, the main idea of the disclosure may be applied to other communication systems having similar backgrounds or channel types through some modifications without significantly departing from the scope of the disclosure.

In a 5G system, a network data collection and analysis function (NWDAF), which is a network function that provides a function of analyzing and providing data collected in a 5G network, may be defined to support network automation. The NWDAF may collect/store/analyze information from the 5G network, and provide an analysis result to at least one network function (NF), and the analysis result may be independently used by each NF.

The 5G mobile communication system supports NFs to use a collection and analysis result of network-related data (hereinafter, referred to as network data) via the NWDAF. This is to provide collection and analysis of network data necessary for each NF to effectively provide its own functions in a centralized form. The NWDAF may collect and analyze network data by using a network slice as a basic unit. However, the scope of the disclosure is not limited to a network slice unit, and the NWDAF may additionally analyze a user equipment (UE), a PDU session, an NF state, and/or various information (e.g., quality of service) obtained from an external service server.

The result of the analysis via the NWDAF is transferred to each NF having requested the corresponding analysis result, and the transferred analysis result may be used to optimize network management functions such as ensuring/improving of quality of service (QoS), traffic control, mobility management, and load balancing.

A unit node which performs each function provided by the 5G network system may be defined as an NF (or referred to as an NF entity or an NF node). Each NF may include, for example, at least one of an access and mobility management function (AMF) that manages access to an access network (AN) and mobility of a user equipment (UE), a session management function (SMF) that performs session-related management, a user plane function (UPF) that manages a user data plane, and a network slice selection function (NSSF) that selects a network slice instance available to a UE.

FIG. 1 illustrates a configuration diagram of a wireless communication network including a network data collection and analysis function (NWDAF) according to an embodiment of the present disclosure.

Referring to FIG. 1, an NWDAF 105 may collect network data in various manners from at least one source NF, for example, NFs in a 5G core network such as an AMF 110, an SMF 115, or UPFs 125, 130, and 135, an application function (AF) for efficiently providing a service, a network exposure function (NEF), or an operation, administration, and maintenance (OAM). The AMF 110 connects to a UE 100 and a radio access network (RAN) 120, and the UPFs 125, 130, and 135 may connect user traffic of the UE 100 through the RAN 120 to at least one data network (DN) 140.

In addition, the NWDAF 105 may provide analysis information of network data collected from a network or the outside to at least one consumer NF. The NWDAF 105 may collect and analyze a load level of a network slice instance to provide the load level to an NSSF, and the NSSF may select a network slice instance available to a specific UE, based on collection information or analysis information relating to a network slice load level. A service-based interface defined in the 5G network may be used to transfer an analysis information request between the NFs 110 and 115 and the NWDAF 105, and the analysis information including an analysis result, and as a transfer method, for example, hypertext transfer protocol (HTTP) and/or JavaScript object notation (JSON) documents may be used.

As an example, the collected data of the NWDAF 105 may include at least one of an application identifier (application ID) from a point coordination function (PCF), IP filter information, a media/application bandwidth, a UE identifier from an AMF, location information, a destination data network name (DNN) from an SMF, a UE IP, a QoS flow bit rate, a QoS flow ID (QFI), a QoS flow error rate, a QoS flow delay, or a traffic usage report from a UPF.

The NWDAF may additionally collect, from an OAM which is an entity which may affect a connection between a UE and a service server in addition to the NFs configuring the core network, at least one of an NF resource condition (resource status), an NF processing capability (throughput), service level agreement (SLA) information, a UE status from a UE, UE application information, a UE usage pattern, an application identifier of a service provided from an AF, a service experience, or a traffic pattern, and use the same for analysis.

Table 1 to Table 3 below show examples of network data collected by the NWDAF. A period and time point in which the NWDAF collects network data from each entity may be different for each entity. In addition, the correlation of collected data may be distinguished via a correlation ID for correlating data of each object to be collected and a timestamp for recording a collection time.

TABLE 1

| Information | Source | Description |
|---|---|---|
| Application ID | AF | To identify the service and support analytics per |
| | | type of service (the desired level of service) |
| IP filter information | AF | Identify a service flow of the UE for the |
| | | application |
| Locations of Application | AF/NEF | Locations of application represented by a list of |
| | | DNAI(s). The NEF may map the AF-Service- |
| | | Identifier information to a list of DNAI(s) when |
| | | the DNAI(s) being used by the application are |
| | | statically defined. |
| Service Experience | AF | Refers to the QoE per service flow as established |
| | | in the SLA and during on boarding. It can be either |
| | | e.g. MOS or video MOS as specified in ITU-T |
| | | P.1203.3 or a customized MOS |
| Timestamp | AF | A time stamp associated to the Service Experience |
| | | provided by the AF, mandatory if the Service |
| | | Experience is provided by the ASP. |

TABLE 2

| Information | Source | Description |
|---|---|---|
| Timestamp | 5GC NF | A time stamp associated with the collected |
| | | information. |
| Location | AMF | The UE location information. |
| SUPI(s) | AMF | If UE IDs are not provided as target of analytics |
| | | reporting for slice service experience, AMF returns |
| | | the UE IDs matching the AMF event filters. |
| DNN | SMF | DNN for the PDU Session which contains the QoS |
| | | flow |
| S-NSSAI | SMF | S-NSSAI for the PDU Session which contains the |
| | | QoS flow |
| Application ID | SMF | Used by NWDAF to identify the application service |
| | | provider and application for the QoS flow |
| IP filter information | SMF | Provided by the SMF, which is used by NWDAF to |
| | | identify the service data flow for policy control |
| | | and/or differentiated charging for the QoS flow |
| QFI | SMF | QoS Flow Identifier |
| QoS flow Bit Rate | UPF | The observed bit rate for UL direction; and |
| | | The observed bit rate for DL direction |
| QoS flow Packet Delay | UPF | The observed Packet delay for UL direction; and |
| | | The observed Packet delay for the DL direction |
| Packet transmission | UPF | The observed number of packet transmission |
| Packet retransmission | UPF | The observed number of packet retransmission |

TABLE 3

| Information | Source | Description |
|---|---|---|
| Timestamp | OAM | A time stamp associated with the collected information. |
| Reference Signal | OAM | The per UE measurement of the received power |
| Received Power | | level in a network cell, including SS-RSRP, CSI- |
| | | RSRP as specified in clause 5.5 of TS 38.331 and |
| | | E-UTRA RSRP as specified in clause 5.5.5 of TS |
| | | 36.331 |
| Reference Signal | OAM | The per UE measurement of the received quality in |
| Received Quality | | a network cell, including SS-RSRQ, CSI-RSRQ as |
| | | specified in clause 5.5 of TS 38.331 and E-UTRA |
| | | RSRQ as specified in clause 5.5.5 of TS 36.331 |
| Signal-to-noise and | OAM | The per UE measurement of the received signal to |
| interference ratio | | noise and interference ratio in a network cell, |
| | | including SS-SINR, CSI-SINR, E-UTRA RS- |
| | | SINR, as specified in clause 5.1 of TS 38.215 |

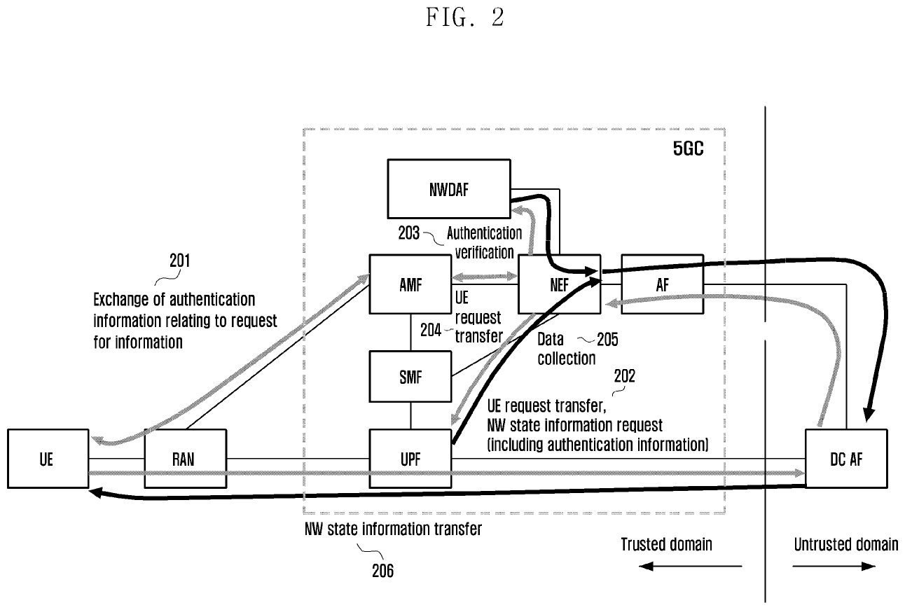

FIG. 2 illustrates a general structure of a wireless communication system in which an AI/ML application of a UE receives and applies network congestion information provided by a communication service provider according to an embodiment of the present disclosure.

Referring to FIG. 2, an AI/ML application may receive network state information, analysis information on a network state, or a combination thereof from an AF (indicated as a DC AF in the drawing) designated for the AI/ML application, and request to modify an AI/ML model to be applied for learning and inference, and to change the size of learning data, based on the received information.

Specifically, a UE may receive, from a network, authentication information (as an example, an authentication key, a certificate, an ID, a password, etc. may be used as authentication information, and the authentication information to be used may be determined differently depending on an authentication scheme which is used) to be used in a process of requesting network state information, analysis information on a network state, or a combination thereof, by using an access procedure to a network or a separately defined message (as an example, a non-access stratum (NAS) message, etc.) (201). The UE may encrypt a network state information request message to be transmitted to the network by using the authentication information, or add a signature to the message, so as to transmit the request message to a data collection AF (DC AF) in charge of collecting state data, analysis data, or a combination thereof requested by the UE (202). The network state information request message may be used to request network state information, analysis information on a network state, or a combination thereof. In the present disclosure, for convenience, an AF in charge of the above-described function is named a DC AF, but may be named with a different name (for example, information exposure application function, etc.) or implemented as a part of an existing network function depending on the implementation. This should be interpreted regardless of the original purpose of the disclosure. When the AF (as an example in the drawing, a DC AF) in charge of collecting data requested by the UE is not in a trusted area of a communication service provider, the request message of the UE may be transferred to a communication service provider network via another AF in the trusted area or directly via an NEF (202). When the AF in charge of data collection is in the trusted area of the communication service provider, the request message of the UE may be directly transferred to the communication service provider network via the NEF. The NEF having received a signal message including a content of the request of the UE may transmit a message content encrypted or signed by the UE to an AMF for message authentication or authentication of the request of the UE (203). The AMF may perform a process of decoding the content of the network state information request message of the UE or verifying the signature by using the authentication information (for example, an authentication key, a certificate, an ID, a password, etc. depending on a authentication scheme which is used) configured with the UE in the previous process, and authenticate that the corresponding UE has transmitted the request message (203). In addition, the AMF may determine whether to accept the provision of network state information or network state analysis information requested by the UE, based on the network state information request message of the UE. The AMF may transfer an authentication result to the NEF, and when the authentication is successful, the NEF may request network state information or analysis information from the AMF, an SMF, a UPF, an NWDAF, etc. in order to collect network information required to generate the network state information or network state analysis information requested by the UE (204). In the process of transferring the authentication result to the NEF, when data encryption or message signing is required for a message which transfers the state information to the UE, the AMF may transfer, to the NEF, authentication information required for message encryption and signature generation, together with the authentication result, and the authentication information may be authentication information preconfigured via a UE and network registration process or a separate process, or authentication information generated therefrom via a security key generation process. In addition, in the process, the NEF may obtain address information and identifiers of necessary network entities such as the AMF, SMF, UPF, and NWDAF which are currently in charge of communication of the UE, by referring to an NRF in order to collect the network information required to generate the network state information or network state analysis information requested by the UE. The NEF may transmit network state and analysis information (the analysis information may include prediction information relating a network state, etc.) collected from the AMF, the SMF, the UPF, the NWDAF, etc. to the AF (a DC AF in the case of the embodiment of the drawing) in charge of collecting data to be transmitted to the UE (205). The AF in charge of data collection may transmit the collected network state and analysis information to the UE (206). The AI/ML application of the UE may determine an appropriate AI/ML model and algorithm to be used for learning and inference by using the network state and analysis information received via the above process. Via this operation, the AI/ML application operating in the UE may select an ML model or algorithm corresponding to a state of a wireless communication system, and receive data in an appropriate form.

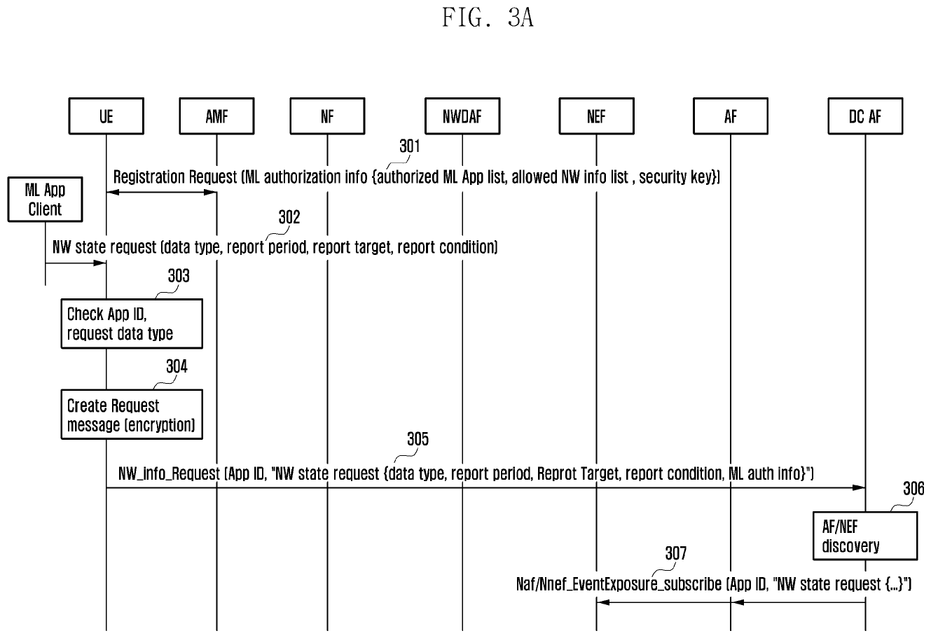

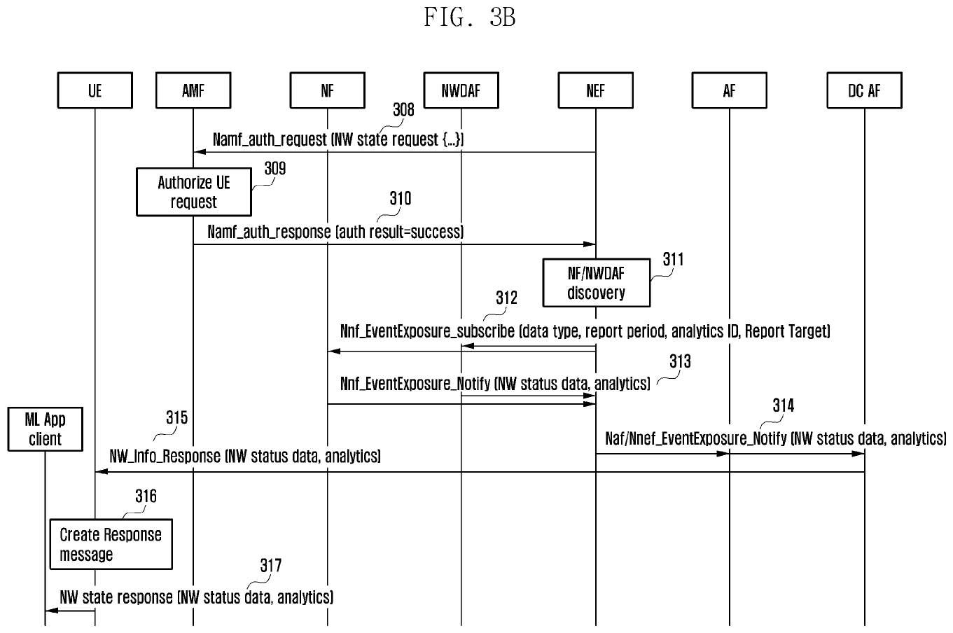

FIGS. 3A and 3B illustrate a signal flow diagram of an operation of receiving a request for transfer of network state information or network state analysis information from an AI/ML application of a UE, collecting the network state information or analysis information, and transferring the information to the UE according to an embodiment of the present disclosure.

Referring to FIG. 3A, in operation 301, a UE may transmit, to a network, information on an AI/ML application of the UE which requires network state information or network state analysis information in a network registration process. AI/ML application information of the UE transferred in the above process may include identifiers of AI/ML applications, a network state parameter list required by each AI/ML application, etc. An AMF having received a request of the UE may request subscription information of the UE from a unified data management (UDM), and may determine whether to accept a network state information request or a network state analysis information request of the UE by referring to a list of allowed AI/ML application identifiers included in the subscription information received from the UDM, a list of network state parameters allowed for each AI/ML application, service provider configuration information stored in the AMF, etc. The AMF may include, in a registration response message, ML Authorization Info information including whether to accept the network state information request or the network state analysis information request of the UE, an identifier list (authorized NL App list) of each AI/ML application allowed for the UE for this purpose and a list of network state parameters allowed for each AI/ML application (allowed NW info list), a network data collection server address, etc., and transfer the message to the UE. In addition, the AMF may include, in the registration response message, authentication information to be used when the UE requests network state information or network state analysis information, and transfer the message, and when requesting the network state information or network state analysis information, the UE may generate signature information by using the received authentication information (for example, a security key, a certificate, etc.), so as to attach the signature information to a request message or encrypt the request message. Whether to use the authentication information to generate signature information or to perform encryption may be previously configured in the UE as system information or the like by a service provider, or transferred to the UE via a separate process. According to an authentication scheme which is applied, for example, the authentication information (for example, a security key, a certificate, an ID, a password, etc.) may be generated by applying an authentication key generation process in the AMF, etc. for each UE identifier or each application identifier or may be generated via a certificate registration process with a certificate authority, and may be transferred from the AMF to the UE and used, or generated and used in the AMF and the UE, respectively.

In operation 302, after the registration process of the UE is completed, or after transferring the AI/ML application information of the UE described in operation 301 via a control message (for example, an NAS message) separately defined to request network state information or network state analysis information, and receiving an authentication result and authentication information relating to the provision of state information of the UE from the AMF, etc., the AI/ML application of the UE may operate to make a request for network state information or network state analysis information required to determine a model and an algorithm to be applied in a learning and inferring process from a communication module via an OS of the UE (or, depending on the implementation, the request may be indirectly transferred via a separate API or a separate system application). In this case, a request signal may include information such as a data type which specifies information required by an application, a report period which specifies a report period, a report target which specifies a session to be reported, and a report condition which specifies a report condition. In operation 303, the communication module having received the request from the application may perform a process of determining whether the request from the application is allowed by a service provider by referring to a list of allowed applications and a list of allowed network state information, received from the network in the registration operation. If the list of allowed applications, a state information list, authentication information, etc. are not received from the network in the registration operation, the UE may perform an operation for transferring the AI/ML application information of the UE described in operation 301 via a control message (for example, an NAS message) separately defined to request network state information or network state analysis information, and receiving an authentication result and authentication information relating to the provision of state information of the UE from the AMF, etc. (the operation is a process of transferring the same content as in operation 301 via a separate message, and is omitted in the example to avoid repetition). In operation 304, the UE may perform a process of generating a control message for requesting network state information or network state analysis information. The control message may include information, such as a data type, a report period, a report target, a report condition, and an application ID, received from the application, and a process of generating and attaching a signature by using the authentication information received in the registration process for message authentication (or received via an exchange procedure of a request message separately defined to request network state information or request network state analysis information described above), or encrypting a control message may be performed. Alternatively, depending on the implementation, it is also possible to determine whether the request of the application is allowed and then transfer authentication information and a server address to the application together with whether to accept the request, and enable the application to directly generate a control message and transfer the message to a designated network data collection server of the network.

In operation 305, the UE transmits the control message for requesting the network state information or network state analysis information, the message being generated in operation 304, to the network data collection server of the network. In operation 306, the network data collection server may perform a process of searching for an AF or NEF address designated by a mobile communication service provider, in order to transfer the request of the UE to the network. In this process, the network data collection server may perform a process of transferring an identifier (for example, an IP address assigned to a UE, a phone number, or an identifier given to a UE by a service provider or a mobile communication network, etc.) of the UE to the network to inquire and receive an AF or NEF address designated by the service provider with respect to the current location or time of the UE, and when a plurality of addresses are received, the network data collection server may select an appropriate AF or NEF among the addresses. In operation 307, the network data collection server may perform a process of transferring the request of the UE to the AF selected in operation 306 or directly transferring the request to the NEF.

Referring to FIG. 3B, in operation 308, the NEF may transmit request information received from the UE to the AMF and request authentication in order to authenticate the request transmitted by the UE. In operation 309, the AMF may perform an authentication process for identifying whether the request information (a signed or encrypted request message) of the UE transmitted by the NEF is generated from the UE, by using the authentication information (for example, a security key, a certificate, an ID, a password, etc.) shared with the UE in the registration process. In addition, the AMF may identify whether the content requested by the UE is a content allowed to the UE or the application of the UE by considering subscription information of the UE, a service provider policy, and reference information configured by a service provider in the AMF, and may determine an authentication result including whether or not to accept the request.

Depending on the implementation, instead of directly authenticating the request of the UE by using the stored authentication information, the AMF may transmit authentication information to the NEF, and cause the NEF to authenticate the request of the UE by using the authentication information received from the AMF. To this end, the AMF may store the authentication information generated in the registration process of the UE in the UDM, and cause the NEF to obtain the stored authentication information from the UDM to authenticate the request message of the UE.

In operation 310, the AMF may transmit the authentication result to the NEF. In addition, in the process of transferring the authentication result to the NEF by the AMF, when data encryption or message signing is required for a message which transfers state information or analysis information to the UE, the AMF may transfer authentication information required for message encryption and signature generation together with the authentication result, and the authentication information may be authentication information preconfigured via a UE and network registration process or a separate process, or authentication information generated therefrom via a security key generation process. In operation 311, when the NEF receives an indication that the authentication is successful, the NEF may perform a process of selecting an NF and NWDAF required to request collection of information required to generate network state information requested by the UE. In the process, the NEF may refer, in the determination, to an NRF in order to obtain address information and an identifier of a necessary network entity among the AMF, the SMF, the UPF, and the NWDAF that are currently in charge of communication of the UE in order to collect network information required to generate the network state information or network state analysis information requested by the UE.

In operation 312, the NEF may transmit a message for requesting to provide network state information or analysis information to the selected NF and NWDAF. The request message for the state information or analysis information may include information such as the type of state information, a report period, and a report reference included in an information provision request message received from the UE, or include a parameter for specifying data to be collected, the parameter being configured based on the information. In operation 313, the NEF may receive necessary network state information and analysis information (the analysis information may include prediction information relating to a network state) from the NF and the NWDAF, and transfer such collection information to the network data collection server either via the AF or directly in operation 314. In this process, when a message is encrypted or a signature for authentication is required according to a configuration of a service provider, the NEF may encrypt the message by using the authentication information (for example, a security key, a certificate, an ID, a password, etc.) received from the AMF (or UDM) in operation 311 or add a signature to the message, so as to transfer the message to the AF or the network data collection server. In operation 315, the network data collection server may report, to the UE, network state information or network state analysis information which meets a reference requested by the UE. Such a report may be repeatedly transferred to the UE whenever the corresponding reference is satisfied by applying a designated report period, report condition, etc. to a report object configured by the UE in a request process. In operation 316, a UE module having received the network state information or analysis information may configure a control message for transferring the received network state information or analysis information to the AI/ML application of the UE via the OS (or, depending on the implementation, the information may be indirectly transferred via a separate API designated for the above purpose or a separate system application). In operation 317, the UE module may transmit the control message to the application of the UE. The AI/ML application of the UE having received the network state information or analysis information may perform a process of selecting a model and algorithm to be applied to learning and inference in consideration of the received information. For example, when data, a providable data transmission rate of which is predicted to decrease according to a movement of the UE, is received, the AI/ML application may perform an operation of changing a model to be applied according to a network state, such as selecting a learning model applicable to the UE although inference performance is poor, instead of applying a split learning model. As another embodiment, when the UE is to receive data in which network congestion is predicted (or released) from the information, the UE may reduce (or enlarge) the size of a model to be applied to learning and inference and transmit information on the reduced (or enlarged) model to an AI/ML application server, so as to receive and use new inference model data.

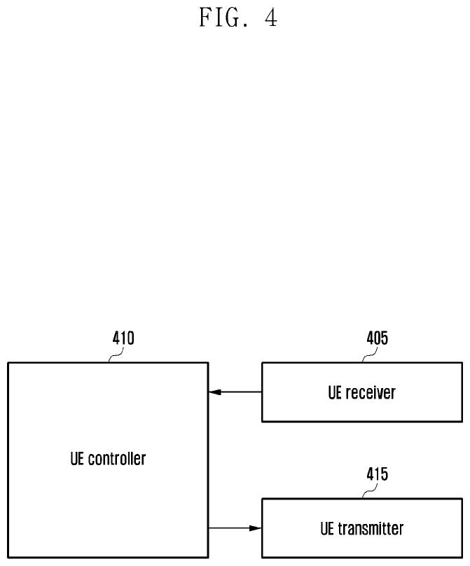

FIG. 4 illustrates a structure of a UE in a wireless communication system according to an embodiment of the present disclosure. Referring to FIG. 4, a UE may include a transceiver which refers to a UE receiver 405 and a UE transmitter 415, a memory (not shown), and a UE controller 410 (or a UE processing unit or processor). The transceiver 405 and 415, the memory, and the UE controller 410 of the UE may operate according to the above-described communication method of the UE. However, the components of the UE are not limited to the above-described examples. For example, the UE may include more or fewer components than the above-described components. In addition, the transceiver, the memory, and the processor may be implemented in a single chip form.

The transceiver may transmit or receive a signal to or from a base station. The signal may include control information and data. To this end, the transceiver may include an RF transmitter configured to up-convert and amplify a frequency of a transmitted signal, and an RF receiver configured to amplify a received signal with low noise and down-convert a frequency of the signal. However, this is only one embodiment of the transceiver, and components of the transceiver are not limited to the RF transmitter and the RF receiver.

In addition, the transceiver may receive a signal via a wireless channel, output the signal to the processor, and transmit the signal output from the processor via the wireless channel.

The memory may store a program and data required for the operation of the UE. In addition, the memory may store control information or data included in a signal transmitted or received by the UE. The memory may be configured as a storage medium such as a ROM, a RAM, a hard disk, a CD-ROM, and a DVD, or a combination of storage media. In addition, a plurality of memories may exist.

In addition, the processor may control a series of processes such that the UE can operate according to the above-described embodiments. A plurality of processors may exist, and the processor may perform a component control operation of the UE by executing a program stored in the memory.

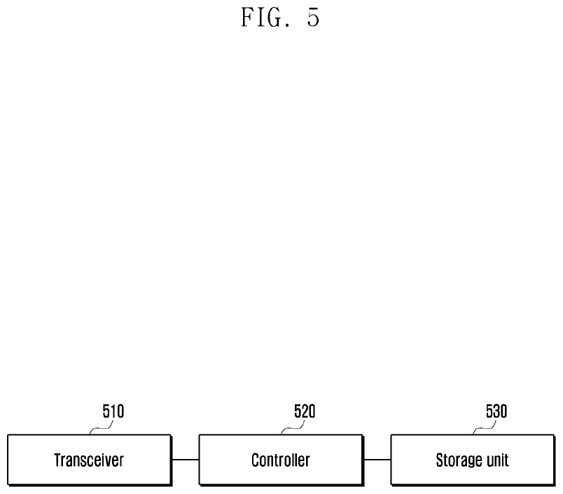

FIG. 5 illustrates a structure of a network entity which performs a network function according to an embodiment of the present disclosure.

A network entity of FIG. 5 may be one of the NWDAF, AMF, SMF, UPF, NS SF, AF, NEF or OAM described above via the embodiments of the present disclosure.

Referring to FIG. 5, the network entity which performs a network function may include a transceiver 510, a controller 520, and a storage unit 530. In the present disclosure, the controller may be defined as a circuit, an application-specific integrated circuit, or at least one processor.

The transceiver 510 may transmit or receive a signal to or from other network entities. For example, the transceiver 510 may transmit or receive a signal or a message to or from an AMF which is a network entity which manages access to an access network and mobility of a UE.

The controller 520 may control an overall operation of a network entity which performs a network function according to the embodiments proposed in the present disclosure. For example, the controller 520 may control a signal flow between blocks so as to perform an operation according to the above-described flowchart.

The storage unit 530 may store at least one of information transmitted or received via the transceiver 510 and information generated via the controller 520.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. For example, a part of one embodiment of the disclosure may be combined with a part of any other embodiment to operate a base station and a terminal.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. In addition, the embodiments of the disclosure as described above are merely for the sake of illustration, and those skilled in the art will appreciate that various changes and modifications may be made thereto and embodiments within equivalent ranges may be possible. Therefore, the true technical scope of protection of the disclosure shall be defined by the appended claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a terminal in a wireless communication system, the method comprising:
transmitting, to an access and mobility management function (AMF), an identifier for an application and network state parameter list for the application, wherein the application is an artificial intelligence (AI) application or a machine learning (ML) application;
receiving, from the AMF, authentication information for a network state information request or a network state analysis information request and address information on a first network entity collecting network state information;
transmitting, to the first network entity based on the address information, the network state information request or the network state analysis information request based on the authentication information;
receiving, from the first network entity, network state information corresponding to the network state information request or network state analysis information corresponding to the network state analysis information request; and
selecting, an AI or ML model based on at least one of the network state information or the network state analysis information.

2. The method of claim 1, wherein:
the network state information request or the network state analysis information request is transmitted to the AMF from the first network entity, and
the network state information request or the network state analysis information request is authenticated by the AMF based on the authentication information.

3. The method of claim 1, further comprising:
receiving, from the AMF, information on whether to accept provision of the network state information, an identifier list of allowed application and a list of network state parameters allowed for the application.

4. The method of claim 3, wherein the information on whether to accept provision of the network state information is determined based on subscription information received from a united data management (UDM).

5. A method performed by an access and mobility management function (AMF) in a wireless communication system, the method comprising:
receiving, from a terminal, an identifier for an application and network state parameter list for the application, wherein the application is an artificial intelligence (AI) application or a machine learning (ML) application;
transmitting, to the terminal, authentication information for a network state information request or a network state analysis information request and address information on a first network entity collecting network state information;
receiving, from the first network entity, the network state information request or the network state analysis information request; and
performing authentication on the received network state information request or the received network state analysis information request based on the authentication information.

6. The method of claim 5, further comprising:
transmitting, to a second network entity, an authentication result for the network state information request or the network state analysis information request,
wherein the second network entity receives network state information or network state analysis information from at least one third network entity based on the authentication result.

7. The method of claim 5, further comprising:
transmitting, to the terminal, information on whether to accept provision of the network state information, an identifier list of allowed application and a list of network state parameters allowed for the application.

8. The method of claim 7, further comprising:
transmitting, to a unified data management (UDM), request for subscription information of the terminal,
receiving, from the UDM, subscription information of the terminal, and
determining whether to accept the provision of the network state information based on the subscription information of the terminal.

9. A terminal in a wireless communication system, the terminal comprising:
a transceiver; and
a controller configured to:
transmit, to an access and mobility management function (AMF), an identifier for an application and network state parameter list for the application, wherein the application is an artificial intelligence (AI) application or a machine learning (ML) application,
receive, from the AMF, authentication information for a network state information request or a network state analysis information request and address information on a first network entity collecting network state information,
transmit, to the first network entity based on the address information, the network state information request or the network state analysis information request based on the authentication information,
receive, from the first network entity, network state information corresponding to the network state information request or network state analysis information corresponding to the network state analysis information request, and
select, an AI or ML model based on at least one of the network state information or the network state analysis information.

10. The terminal of claim 9, wherein:
the network state information request or the network state analysis information request is transmitted to the AMF from the first network entity, and
the network state information request or the network state analysis information request is authenticated by the AMF based on the authentication information.

11. The terminal of claim 9, wherein the controller is further configured to:
receive, from the AMF, information on whether to accept provision of the network state information, an identifier list of allowed application and a list of network state parameters allowed for the application.

12. The terminal of claim 11, wherein the information on whether to accept provision of the network state information is determined based on subscription information received from a united data management (UDM).

13. An access and mobility management function (AMF) in a wireless communication system, the AMF comprising:
a transceiver; and
a controller configured to:
receive, from a terminal, an identifier for an application and network state parameter list for the application, wherein the application is an artificial intelligence (AI) application or a machine learning (ML) application,
transmit, to the terminal, authentication information for a network state information request or a network state analysis information request and address information on a first network entity collecting network state information,
receive, from the first network entity, the network state information request or the network state analysis information request, and
perform authentication on the received network state information request or the received network state analysis information request based on the authentication information.

14. The AMF of claim 13, wherein the controller is further configured to:
transmit, to a second network entity, an authentication result for the network state information request or the network state analysis information,
wherein the second network entity receives network state information or network state analysis information from at least one third network entity based on the authentication result.

15. The AMF of claim 13, wherein the controller is further configured to:
transmit, to the terminal, information on whether to accept provision of the network state information, an identifier list of allowed application and a list of network state parameters allowed for the application.

16. The AMF of claim 15, wherein the controller is further configured to:
transmit, to a unified data management (UDM), a request for subscription information of the terminal,
receive, from the UDM, subscription information of the terminal, and
determine whether to accept the provision of the network state information based on the subscription information of the terminal.
